(19) United States
(12) Patent Application Publication
(10) Pub. No.: US 2016/0224501 A1
(43) Pub. Date: Aug. 4, 2016

(54) ADAPTATION DEVICE FOR A BUS SYSTEM, AND METHOD FOR OPERATING A CAN SUBSCRIBER STATION AND A CAN FD SUBSCRIBER STATION IN A BUS SYSTEM

(71) Applicant: ROBERT BOSCH GMBH, Stuttgart (DE)

(72) Inventor: Patrick Nickel, Birstein (DE)

(21) Appl. No.: 15/021,200

(22) PCT Filed: Oct. 9, 2014
(86) PCT No.: PCT/EP2014/071699

§ 371 Date: Mar. 10, 2016

(30) Foreign Application Priority Data
Oct. 9, 2013 (DE) 10 2013 220 377.2

(51) Int. Cl. G06F 13/40; G06F 13/42; G06F 11/07

(52) U.S. Cl. CPC G06F 13/4031; G06F 11/0745; G06F 11/0751; G06F 11/079; G06F 13/4282

(57) ABSTRACT

An adaptation device for a bus system and a method for operating a CAN subscriber station and a CAN FD subscriber station in a bus system are provided. The adaptation device includes a reception path evaluation unit for evaluating received messages with regard to whether or not the received message is a message according to the CAN FD specification, and a reception path output unit for outputting a dummy frame to a communication control device of a CAN subscriber station for the bus system if the result of an evaluation by the reception path evaluation unit is that the received message is a message according to the CAN FD specification.

### FIELD

The present invention relates to an adaptation device for a bus system, and a method for operating a CAN subscriber station and a CAN FD subscriber station in a bus system.

### BACKGROUND INFORMATION

Automobile bus systems are continuously being developed for higher bandwidths, shorter latency times, and more rigorous real-time capability. For interlinking components such as a control unit, an actuator, a sensor, a gateway, etc., with the aid of a bus system, the CAN bus is very widespread in automotive applications, and due to its parallel topology it is very well suited for numerous applications. As a result of the ever-increasing data volume, the migration of existing control units and vehicle platforms to higher data rates is made possible by the introduction of CAN FD.

In the CAN bus system, messages are transmitted via the CAN protocol, as described in the CAN specification in ISO 11898. To this end, technologies, for example CAN FD, have also been proposed recently in which messages are transmitted according to the specification “CAN with Flexible Data Rate, Specification Version 1.0” (source: http://www.semiconductors.bosch.de). In such technologies, the maximum possible data rate is increased above a value of 1 Mbit/s by using higher clock speeds in the range of the data fields.

In the CAN bus system, previous CAN-based network components, for example a control unit, an actuator, a sensor, or a gateway, for the most part use the CAN controllers which are integrated into microcontrollers for communication. This allows a very cost-effective design of the components with regard to the communication path including a CAN transceiver and a common mode choke (CMC). Alternatively, integrated CAN controllers exist which may be connected to a microcontroller via an SPI interface, for example.

It is disadvantageous that it has been necessary thus far to design a bus in an integrated manner with the same kind of subscriber stations, for example only CAN subscriber stations or only CAN FD subscriber stations. The reason is that errors would otherwise occur in the network due to the incompatibility of existing CAN subscriber stations with CAN FD subscriber stations. As a result of these errors, although conventional CAN subscriber stations tolerate the arbitration phase of CAN FD, they may assess the high-rate average data segment as faulty due to being unable to interpret same. The existing CAN subscriber stations arrive at the assessment, for example, that the bit stuffing does not correspond to the required form. As a result, a CAN subscriber station could then send an error in the form of an error frame to the bus, thus interfering with ongoing communication.

It is also problematic that it may possibly be desired to use existing components of a bus system. This is presently not easily possible. Instead, it is usually necessary to replace all CAN controllers. In the case of a CAN controller which is integrated into the microcontroller, this makes it necessary to replace the microcontroller. With a stand-alone CAN controller, the entire stand-alone CAN controller must be replaced.

### SUMMARY

An object of the present invention is to provide an adaptation device for a bus system and a method which solve the problems mentioned above. In particular, the aim is to provide an adaptation device for a bus system and a method in which, if necessary, CAN FD components are also operable in a cost-effective manner in a CAN bus system, and vice versa.

The object may be achieved by an example adaptation device for a bus system. The example adaptation device includes a reception path evaluation unit for evaluating received messages with regard to whether or not the received message is a message according to the CAN FD specification, and a reception path output unit for outputting a dummy frame to a communication control device of a CAN subscriber station for the bus system if the result of an evaluation by the reception path evaluation unit is that the received message is a message according to the CAN FD specification.

The subscriber station cost-effectively provides the option for all CAN subscriber stations to have a CAN FD tolerance when CAN FD subscriber stations are used in the network or bus system. Thus, with the subscriber station it is possible to use CAN components and CAN FD components in a bus system without errors occurring due to such a mixed operation. For example, sending a CAN FD frame no longer results in an interruption of the data transmission due to an error frame.

The adaptation device offers the advantage that existing systems are adaptable with very little outlay of hardware and software.

The dummy frame may represent a correct CAN structure in the CAN format.

It is possible for the reception path evaluation unit to be designed for evaluating an EDL bit in the arbitration phase of the bus system. In this regard, the reception path evaluation unit may also be designed for evaluating a BRS bit. Additionally or alternatively, the reception path evaluation unit may be designed for evaluating other features or patterns in a message which allow a conclusion to be drawn that the message is a CAN FD frame.

It is in addition possible for the reception path evaluation unit to also be designed for detecting the length of a message. For detecting the length of a frame, the reception path evaluation unit may be designed for decoding a DLC field or for detecting bus activity and a termination segment.

The example adaptation device includes a transmission path evaluation unit for detecting whether or not an error frame is sent in the transmission path of a communication control device of a CAN subscriber station for the bus system, and a transmission path output unit for blocking an error frame if the transmission path evaluation unit has identified an error frame in the transmission path.

The first and second adaptation devices described above may be part of a subscriber station for a bus system which also includes a communication control device for controlling the communication in the bus system, and a transceiver for transmitting or receiving messages from or for the subscriber station.

In another embodiment of the subscriber station, the first adaptation device may be part of the communication control device or part of the transceiver, and/or the second adaptation device may be part of the communication control device or part of the transceiver.

The subscriber station described above may be part of a bus system which includes a bus line, and at least two subscriber stations which are connected to one another via the bus line in such a way that they may communicate with one another. At least one of the at least two subscriber stations is a subscriber station described above.

Moreover, the above-mentioned object is achieved by a method for operating a CAN subscriber station and a CAN FD subscriber station in a bus system. The method includes the steps of evaluating, using a reception path evaluation unit, received messages with regard to whether or not the received message is a message according to the CAN FD specification, and outputting, using a reception path output unit, a dummy frame to a communication control device of a CAN subscriber station for the bus system if the result of an evaluation by the reception path evaluation unit is that the received message is a message according to the CAN FD specification, and/or includes the two steps of evaluating, using a transmission path evaluation unit whether or not an error frame is sent in the transmission path of a communication control device of a CAN subscriber station for the bus system, and blocking, using a transmission path output unit, an error frame if the transmission path evaluation unit has identified an error frame in the transmission path.

The method provides the same advantages as mentioned above with regard to the adaptation device.

Further possible implementations of the present invention also include combinations, not specifically mentioned, of features or specific embodiments described above or in the following discussion with regard to the exemplary embodiments. Those skilled in the art will also add individual aspects as refinements or supplements to the particular basic form of the present invention.

### BRIEF DESCRIPTION OF THE DRAWINGS

The present invention is described in greater detail below with reference to the figures and based on exemplary embodiments.

FIG. 1 shows a simplified block diagram of a bus system according to a first exemplary embodiment.

FIG. 2 shows an electrical circuit diagram of a transceiver of the bus system together with an adaptation device according to the first exemplary embodiment.

FIG. 3 shows a CAN FD frame structure which is used by the adaptation device according to the first exemplary embodiment;

FIG. 4 shows a flow chart of a method according to the first exemplary embodiment;

FIG. 5 shows an electrical circuit diagram of a transceiver of a bus system together with an adaptation device according to a second exemplary embodiment.

FIG. 6 shows a flow chart of a method according to the second exemplary embodiment; and

FIG. 7 shows an electrical circuit diagram of a transceiver of a bus system together with an adaptation device according to a third exemplary embodiment.

Unless stated otherwise, similar or functionally equivalent elements are denoted by the same reference numerals in the figures.

### DETAILED DESCRIPTION OF EXAMPLE EMBODIMENTS

FIG. 1 shows a bus system 1 in which messages or signals may be transmitted via the CAN protocol, and messages or signals may be transmitted according to the CAN FD specification. If necessary, however, it is also possible for messages or signals to be transmitted only via the CAN protocol, or for messages or signals to be transmitted only according to the CAN FD specification. Bus system 1 may be used in a vehicle, in particular a motor vehicle, an aircraft, etc., or in a hospital, and so forth.

In FIG. 1, bus system 1 includes a plurality of subscriber stations 10, 20, 30, each of which is connected to a bus line 40. Messages 45, 46, 47 in the form of signals may be transmitted between individual subscriber stations 10, 20, 30 via bus line 40. Subscriber stations 10, 20, 30 may be, for example, control units or display devices of a motor vehicle.

As shown in FIG. 1, subscriber stations 10, 30 each include a communication control device 11, an adaptation device 12, and a transceiver 13. In contrast, subscriber station 20 includes a communication control device 14 and a transceiver 13. Transceivers 13 of subscriber stations 10, 20, 30 are each directly connected to bus line 40, even though this is not illustrated in FIG. 1.

Communication control devices 11, 14 are used for controlling a communication of the particular subscriber station 10, 20, via bus line 40 with another subscriber station of subscriber stations 10, 20, 30 connected to bus line 40. Communication control devices 11 generate and process messages, for example messages 45, 47, according to the CAN protocol. Communication control devices 11 may be designed as a conventional CAN controller. Consequently, subscriber stations 10, 30 may also be referred to as CAN subscriber stations 10, 30. Communication control device 14 generates and processes messages, for example message 46, according to the CAN FD specification. Communication control device 11 may be designed as a conventional CAN FD controller. Consequently, subscriber station 20 may also be referred to as a CAN FD subscriber station 20.

Adaptation device 12 undertakes adaptation actions for the case that a message 46 is transmitted according to the CAN FD specification, as described in greater detail below. Transceiver 13 may be designed as a conventional CAN transceiver.

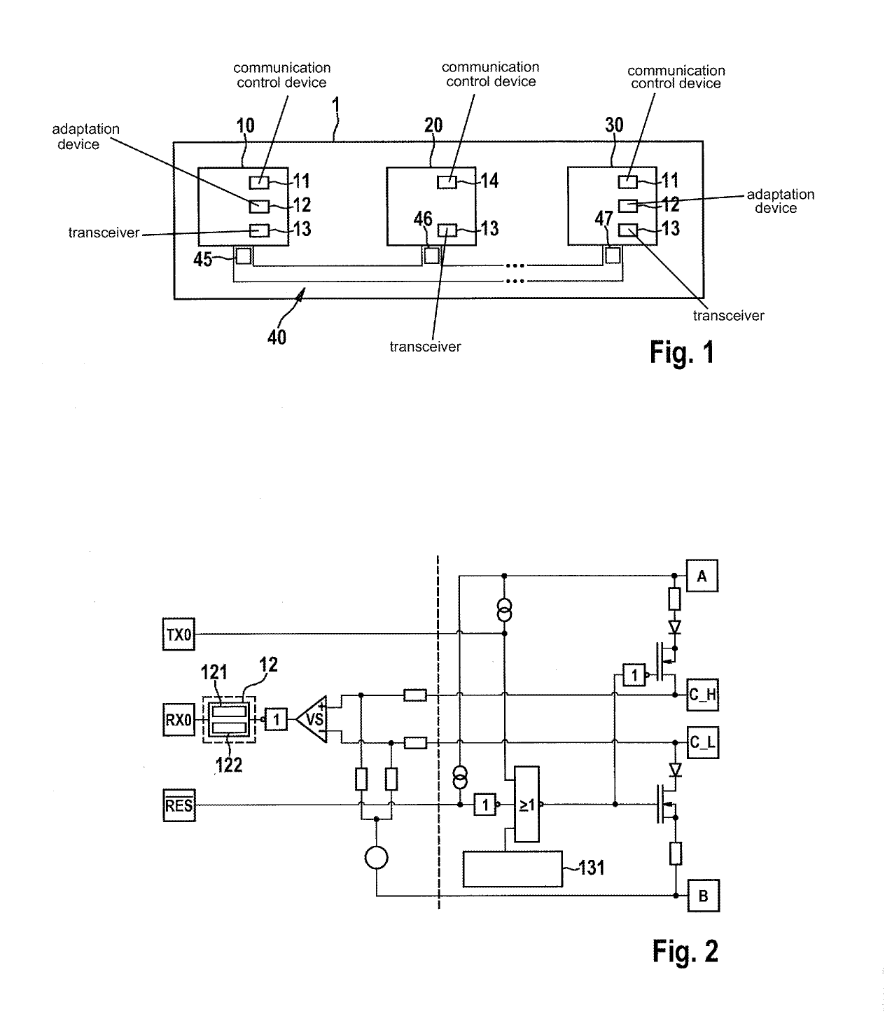

FIG. 2 shows the arrangement of adaptation device 12 between communication control device 11 and transceiver 13 in greater detail. Communication control device 11 is situated on the left side of adaptation device 12 in FIG. 2, at terminals TX0, RX0, and inverted terminal RES. Transceiver 13, as a conventional CAN transceiver, is situated on the right side of adaptation device 12 in FIG. 2. In the present exemplary embodiment, adaptation device 12 is situated in the reception path between communication control device 11 and transceiver 13, i.e., at terminal RX0.

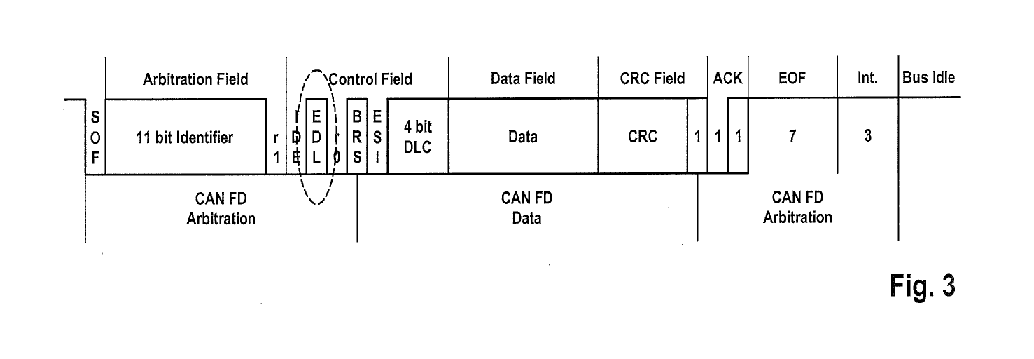

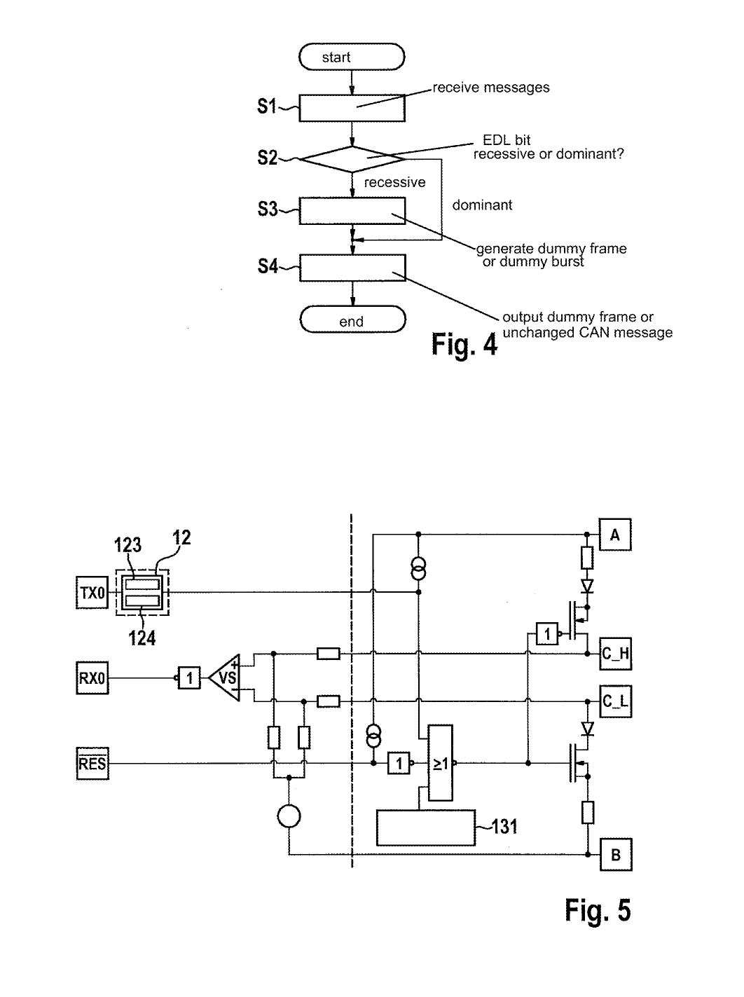

As schematically illustrated in FIG. 2, adaptation device 12 includes a reception path evaluation unit 121 and a reception path output unit 122. Reception path evaluation unit 121 is used for evaluating bus signals as messages 45, 46, 47 received from transceiver 13. Reception path evaluation unit 121 evaluates signals or messages 45, 46, 47 with regard to whether or not the received message is a message according to the CAN FD specification. Reception path evaluation unit 121 uses the structure of a CAN FD frame, as shown in FIG. 3. The functions of reception path evaluation unit 121 and of reception path output unit 122 are described in greater detail with reference to FIG. 4. Transceiver 13 also includes an overtemperature cutoff unit 131.

According to FIG. 3, in a CAN FD frame the arbitration field is followed by a control field. The control field includes, among other things, an extended data length (EDL) bit, a bit rate switch (BRS) bit, and a data length code (DLC) (indicating the number of bytes in the data field) field. In addition, a termination segment containing ACK and EOF is included in the CAN FD frame.

FIG. 4 depicts the method carried out in the present exemplary embodiment for operating a CAN subscriber station 10, 30 and a CAN FD subscriber station 20 in bus system 1. In the method, after the start of the method, adaptation device 12 receives one of messages 45, 46, 47 from transceiver 13 in a step S1. The method subsequently continues with a step S2.

In step S2, reception path evaluation unit 121 evaluates the message of messages 45, 46, 47 received in step S1. In the present exemplary embodiment, reception path evaluation unit 121 evaluates whether the EDL bit is recessive or dominant. In the case of an EDL bit, which designates a CAN FD frame, in particular a recessive EDL bit, the method continues with a step S3. In the case of some other EDL bit, in particular a dominant EDL bit, a normal CAN message, not a CAN FD frame, is present, so that the method continues with a step S4.

Reception path output unit 122 generates a dummy frame or dummy burst in step S3. The dummy frame generally represents a correct CAN structure, with bit stuffing, among other things, in a conventional format. The method subsequently continues with a step S4.

In step S4, reception path output unit 122 outputs the dummy frame or the unchanged CAN message in the receiving direction, i.e., to communication control device 11 via terminal RX0. The method is subsequently terminated.

As a result, adaptation device 12 outputs normal CAN messages, without modification, to communication control device 11, and appropriately modifies CAN FD messages for a CAN subscriber station 10, 30.

According to one modification of the first exemplary embodiment, reception path evaluation unit 121 also evaluates the BRS bit in addition to the EDL bit in step S2. Thus, the information concerning an expanded data length of the message is or is not evaluated, and in addition, information with regard to an increased bit rate is or is not evaluated. If the EDL bit as well as the BRS bit indicate that a CAN FD frame is present, i.e., in the case in particular of a recessive EDL bit and in particular a recessive BRS bit, the method continues with a step S3. Otherwise, the method continues with step S4. As an alternative or in addition to the BRS bit, one or multiple other features of the CAN FD frame may be evaluated in step S2 in order to reliably conclude that the message is a CAN FD frame.

According to another modification of the first exemplary embodiment, in step S2, in addition to the CAN FD recognition and optionally modified relaying in the reception path, reception path evaluation unit 121 may also detect the length of one message of messages 45, 46, 47. This may take place either via a decoding of the data length code (DLC) (indicating the number of bytes in the data field) field or by detecting the bus activity and the termination segment (ACK, EOF) in the CAN FD frame. In the relaying to communication control device 11 at the RX0 terminal, the dummy frame content is configured over the appropriate length and terminated at the end of the CAN frame in a valid state. This includes the check sum (CRC), ACK, and EOF.

It is noted that in the first exemplary embodiment and its modifications, due to the adaptation by adaptation device 12, incorrect messages, in particular concerning dummy frame contents, are precluded from arriving at the CAN node, since unambiguous addressing of all messages already takes place in the arbitration portion. A CAN FD message is always provided with a CAN address which is free and does not trigger any collisions. A message which uses a previously unused address is not interpreted or utilized, regardless of the content.

FIG. 5 shows the arrangement of an adaptation device 12 according to a second exemplary embodiment, in which adaptation device 12 is once again situated between communication control device 11 and transceiver 13, as in the first exemplary embodiment. However, adaptation device 12 according to the present exemplary embodiment is situated in the transmission path between communication control device 11 at terminal TX0 and transceiver 13. Transceiver 13 is once again a conventional CAN transceiver, and is situated on the right side of adaptation device 12 in FIG. 5.

In the present exemplary embodiment, adaptation device 12 includes a transmission path evaluation device 123 and a transmission path output device 124. Transmission path evaluation device 123 is used for evaluating one message of messages 45, 46, 47 sent from communication control device 11 to transceiver 13. Transmission path evaluation unit 123 evaluates the message with regard to whether or not the sent message is an error frame.

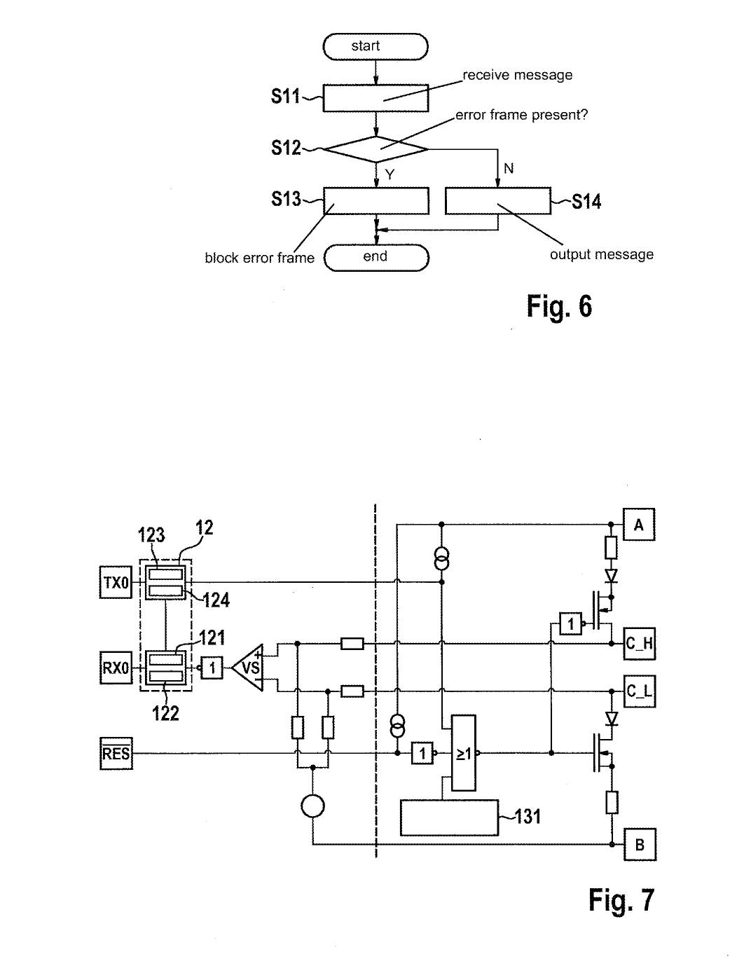

FIG. 6 depicts the method carried out in the present exemplary embodiment for operating a CAN subscriber station 10, 30 and a CAN FD subscriber station 20 in bus system 1. In the method, after the start of the method, adaptation device 12 receives one message of messages 45, 46, 47 from communication control device 11 via terminal TX0 in a step S11. The method subsequently continues with a step S12.

In step S12, transmission path evaluation unit 123 evaluates the message received from communication control device 11 in step S11, as described above. If an error frame is present, the method continues with a step S13. Otherwise, the method continues with a step S14.

Transmission path output unit 124 blocks the error frame in step S13. The method is subsequently terminated.

In step S14, transmission path output unit 124 outputs the message of messages 45, 46, 47 sent from communication control device 11 in the transmission direction, i.e., to transceiver 13. The method is subsequently terminated.

In other respects, the present exemplary embodiment is designed as described for the first exemplary embodiment.

As shown in FIG. 7, according to a third exemplary embodiment, adaptation device 12 includes reception path evaluation unit 121 and reception path output unit 122 according to the first exemplary embodiment and/or a modification thereof, as well as transmission path evaluation device 123 and transmission path output device 124 according to the second exemplary embodiment.

Thus, the method according to FIG. 4 as well as the method according to FIG. 6 are carried out in the present exemplary embodiment.

In summary, according to the exemplary embodiments described above, for example a novel type of transceiver is used, which in comparison to existing transceivers, in addition to the customary bus drivers on the transmission side and Schmitt triggers on the reception side contains an additional logic system, namely, adaptation device 12. This logic system is much simpler compared to a complete CAN controller; however, in the reception case it is able to evaluate the arbitration phase, for example, and to relay a dummy frame to communication control device 11 when CAN FD frames are identified. Additionally or alternatively, in the transmission case the error frame may be blocked. The CAN transceiver is thus utilized as a bridge between a mixed network and conventional CAN-based control units, for example with integrated conventional CAN controllers in the chip. By replacing or otherwise providing only this component (CAN transceiver) of a control unit, a user may insert existing components into a rapid CAN FD network, and conversely, may also introduce CAN FD-based components into a CAN-based network.

All of the above-described embodiments of bus system 1, subscriber stations 10, 20, 30, and the method according to the first through third exemplary embodiments may be used individually or in all possible combinations. In addition, in particular the following modifications are conceivable.

Bus system 1 according to the first through third exemplary embodiments described above is described based on a CAN protocol-based bus system. However, bus system 1, 2 according to the first through third exemplary embodiments may also be some other type of communication network. It is advantageous, but not absolutely necessary, to ensure for bus system 1, at least for certain time periods, an exclusive, collision-free access of a subscriber station 10, 20, 30 to bus line 40 or a shared channel of bus line 40.

Bus system 1, 2 according to the first through third exemplary embodiments is a network in which in particular a CAN network, a CAN FD network, a LIN network, or a FlexRay network may be operated in parallel.

The number and configuration of subscriber stations 10, 20, 30 in bus system 1 according to the first through third exemplary embodiments is arbitrary. In particular, it is also possible that only subscriber stations 10 or subscriber stations 30 are present in bus system 1 of the first through third exemplary embodiments.

The evaluation of bus signals or messages 45, 46, 47 may take place at various locations in the transmission/reception path of subscriber stations 10, 30. In addition, various properties of a CAN signal may be utilized for detecting a CAN FD frame in order to achieve an advantageous implementation. In addition to the evaluation of the CAN FD identifier bits (EDL, BRS), an evaluation based on the address ranges may also take place.

For expanding the functionality of adaptation device 12, an addition of configurable/programmable address range filters is possible.

For assisting with a power-saving functionality in the sense of pretended networking and partial networking, the above-mentioned functions of adaptation device 12 may be integrated into the component of adaptation device 12 to be modified. For this purpose, additional control lines to the outside are possible in order to “wake up” hardware components from a power-saving mode. In addition, buffers may be inserted to be able to relay messages in a delayed manner.

With regard to the first through third exemplary embodiments, the functionality of the exemplary embodiments described above allows implementation in a transceiver, i.e., a transceiver 13, or in a communication control device 11, and the like. In addition, integration into existing components of the CAN transmission/reception path, in particular into the common mode choke (CMC), and the like is possible. Additionally or alternatively, integration into existing products, in particular as a separate component, is possible.

1-10. (canceled)

11. An adaptation device for a bus system, comprising:
a reception path evaluation unit to evaluate a received message with regard to whether or not the received message is a message according to the CAN FD specification; and
a reception path output unit to output a dummy frame to a communication control device of a CAN subscriber station for the bus system if the result of the evaluation by the reception path evaluation unit is that the received message is a message according to the CAN FD specification.

12. The adaptation device as recited in claim 11, wherein the dummy frame represents a correct CAN structure in the CAN format.

13. The adaptation device as recited in claim 11 wherein the reception path evaluation unit is designed to evaluate an EDL bit in an arbitration phase of the bus system.

14. The adaptation device as recited in claim 13, wherein the reception path evaluation unit is also designed to evaluate a BRS bit.

15. The adaptation device as recited in claim 11, wherein the reception path evaluation unit is also designed to detect a length of a message.

16. The adaptation device as recited in claim 15, wherein the reception path evaluation unit is designed to decode a DLC field for detecting the length of a frame or for detecting a bus activity and a termination segment.

17. An adaptation device for a bus system, comprising:
a transmission path evaluation unit to evaluate whether or not an error frame is sent in a transmission path of a communication control device of a CAN subscriber station for the bus system; and
a transmission path output unit to block an error frame if the transmission path evaluation unit has identified an error frame in the transmission path.

18. A subscriber station, comprising:
a communication control device to control the communication in a bus system;
a transceiver to transmit or receive messages from or for the subscriber station; and
a first adaptation device including:
a reception path evaluation unit to evaluate a receive message with regard to whether or not the received message is a message according to the CAN FD specification; and
a reception path output unit to output a dummy frame to a communication control device of a CAN subscriber station for the bus system if the result of the evaluation by the reception path evaluation unit is that the received message is a message according to the CAN FD specification; and
a second adaptation device including:
a transmission path evaluation unit to evaluate whether or not an error frame is sent in a transmission path of a communication control device of a CAN subscriber station for the bus system; and
a transmission path output unit to block an error frame if the transmission path evaluation unit has identified an error frame in the transmission path.

19. The subscriber station as recited in claim 18, wherein at least one of: i) the first adaptation device is part of the communication control device or part of the transceiver, and ii) the second adaptation device is part of the communication control device or part of the transceiver.

20. A method for operating a CAN subscriber station and a CAN FD subscriber station in a bus system, comprising:
evaluating, using a reception path evaluation unit, received messages with regard to whether or not the received message is a message according to the CAN FD specification; and
outputting, using a reception path output unit, a dummy frame to a communication control device of a CAN subscriber station for the bus system if the result of the evaluation by the reception path evaluation unit is that the received message is a message according to the CAN FD specification.

21. A method for operating a CAN subscriber station and a CAN FD subscriber station in a bus system, comprising:
evaluating, using a transmission path evaluation unit, whether or not an error frame is sent in a transmission path of a communication control device of a CAN subscriber station for the bus system; and
blocking, using a transmission path output unit, an error frame if the transmission path evaluation unit has identified an error frame in the transmission path.
